(19) United States
(12) Patent Application Publication
(10) Pub. No.: US 2024/0098124 A1
(43) Pub. Date: Mar. 21, 2024

(54) CONFERENCE CREATION METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Tieming HUANG, Shenzhen (CN); Jingzhong LI, Shenzhen (CN); Bin LI, Shenzhen (CN); Qiang HUANG, Shenzhen (CN); Chuwei ZENG, Shenzhen (CN)

(21) Appl. No.: 18/520,311

(22) Filed: Nov. 27, 2023

Related U.S. Application Data
(63) Continuation of application No. PCT/CN2023/078678, filed on Feb. 28, 2023.

(30) Foreign Application Priority Data
Mar. 1, 2022 (CN) 202210195757.5

(51) Int. Cl. H04L 65/403; H04L 51/10

(52) U.S. Cl. CPC H04L 65/403; H04L 51/10

(57) ABSTRACT

This application disclose a conference creation method performed by a computer device. The method includes: displaying a group conversation page of a group in a first message application, the group conversation page comprising a conference initiation control; in response to a triggering operation for the conference initiation control, creating a target conference corresponding to a conference application and transmitting conference invitation information to a conference member of the target conference, the conference member of the target conference comprising at least one first member of the first message application; and when an acquired response state of the conference member in the target conference for the conference invitation information is a preset state and an association relationship between the response conference member and the at least first member of the first message application satisfies a preset relationship condition, allowing the response conference member to join the target conference.

### CROSS-REFERENCE TO RELATED APPLICATIONS

This application is a continuation application of PCT Patent Application No. PCT/CN2023/078678, entitled “CONFERENCE CREATION METHOD AND APPARATUS, DEVICE, STORAGE MEDIUM, AND PROGRAM PRODUCT” filed on Feb. 28, 2023, which is based upon and claims priority to Chinese Patent Application No. 2022101957575, entitled “CONFERENCE CREATION METHOD AND APPARATUS, DEVICE, STORAGE MEDIUM, AND PROGRAM PRODUCT” filed on Mar. 1, 2022, all of which is incorporated by reference in its entirety.

### FIELD OF THE TECHNOLOGY

This application relates to the field of Internet technologies, and in particular, to a conference creation method and apparatus, a device, a storage medium, and a program product.

### BACKGROUND OF THE DISCLOSURE

With rapid development of Internet technologies, online conferences are also applied more and more widely. In existing conference creation methods, conferences are mostly created by initiating a conference in a standalone Application (App for short) and selecting conference participants, or by selecting conference participants in advance and then pulling up a conference.

During researches and practices on relevant technologies, the applicant of this application has found that processes of conference creation methods in related technologies are cumbersome, especially for scenarios with diverse conference member sources, conferences cannot be created quickly, resulting in low efficiency of conference creation.

### SUMMARY

Embodiments of this embodiment provide a conference creation method and apparatus, a device, a storage medium, and a program product, which can improve the conference creation speed, thereby improving the conference creation efficiency.

The embodiments of this application provide a conference creation method performed by a computer device, the method including:

displaying a group conversation page of a group in a first message application, the group conversation page comprising a conference initiation control;

in response to a triggering operation for the conference initiation control, creating a target conference corresponding to a conference application and transmitting conference invitation information to a conference member of the target conference through a message channel of the first message application, the conference member of the target conference comprising at least one first member of the first message application; and

when an acquired response state of the conference member in the target conference for the conference invitation information is a preset state and an association relationship between the response conference member and the at least first member of the first message application satisfies a preset relationship condition, allowing the response conference member to join the target conference.

The embodiments of this application may further provide a conference creation method, including:
displaying a group conversation page of a group in a first message application, the group conversation page including a conference initiation control, and the group including at least one object;
creating, in response to a triggering operation for the conference initiation control, a target conference corresponding to a conference application, the conference member of the target conference including at least one first object of the group, the first object being an object in a first message system, and the first message system being a message system corresponding to the first message application; and
transmitting the conference invitation information of the target conference for the conference member of the target conference.

In addition, the embodiments of this application further provide a non-transitory computer-readable storage medium. The non-transitory computer-readable storage medium stores a plurality of instructions, and the instructions are suitable to be loaded by a processor of a computer device and causes the computer device to perform steps in any conference creation method provided by the embodiments of this application.

In addition, the embodiments of this application further provide a computer device, including a processor and a memory. The memory stores an application. The processor is configured to run the application in the memory to implement the conference creation method provided by the embodiments of this application.

The embodiments of this application further provide a computer program product or a computer program. The computer program product or the computer program includes computer instructions. The grabbing instructions are stored in a computer-readable storage medium. A processor of the computer device reads the computer instructions from the computer-readable storage medium. The processor executes the computer instructions, so that the computer device performs steps of the conference creation method provided by the embodiments of this application.

The embodiments of this application have the following beneficial effects:

According to the embodiments of this application, the conference initiation control is displayed in the group conversation page of the group, so as to quickly create the target conference corresponding to the conference application in response to the triggering operation for the conference initiation control in the group conference page. For scenarios with diverse conference member sources, especially for the scenarios with conference members from a plurality of groups, the conference creation speed is greatly improved. Meanwhile, in the scenarios with diverse conference member sources and diverse conference reference ways, a response state and an association relationship of response conference members are authenticated, so that the response conference members satisfying a condition are allowed to join the target conference, which guarantees the security of a conference environment on the basis of quickly creating a conference, thereby improving the conference creation efficiency.

### BRIEF DESCRIPTION OF THE DRAWINGS

In order to describe the technical solutions in the embodiments of the present application more clearly, the drawings required to be used in descriptions about the embodiments will be simply introduced below. Obviously, the drawings in the following descriptions are only some embodiments of the present application. Those skilled in the art may further obtain other drawings according to these drawings without creative work.

FIG. 1 is a schematic diagram of an implementation scenario of a conference creation method provided by an embodiment of this application.

FIG. 2 is a schematic flowchart of a conference creation method provided by an embodiment of this application.

FIG. 3 is a schematic diagram of a group conversation page of a conference creation method provided by an embodiment of this application.

FIG. 4 is a schematic diagram of a conference member selection page of a conference creation method provided by an embodiment of this application.

FIG. 5 is a schematic diagram of second object association of a conference creation method provided by an embodiment of this application.

FIG. 6 is a schematic diagram of a conference invitation process of a conference creation method provided by an embodiment of this application.

FIG. 7 is a schematic diagram of first conference invitation information of a conference creation method provided by an embodiment of this application.

FIG. 8 is a schematic diagram of a second conference invitation message of a conference creation method provided by an embodiment of this application.

FIG. 9 is a schematic diagram of a specific process of a conference creation method provided by an embodiment of this application.

FIG. 10 is a schematic diagram of another process of a conference creation method provided by an embodiment of this application.

FIG. 11 is still another schematic flowchart of a conference creation method provided by an embodiment of this application.

FIG. 12 is a schematic structural diagram of a conference creation apparatus provided by an embodiment of this application.

FIG. 13 is a schematic structural diagram of a computer device provided by an embodiment of this application.

### DESCRIPTION OF EMBODIMENTS

The technical solutions in embodiments of this application are clearly and completely described below with reference to the accompanying drawings in the embodiments of this application. Apparently, the described embodiments are merely some rather than all of the embodiments of this application. All other embodiments obtained by a person skilled in the art based on the embodiments of this application without creative efforts shall fall within the protection scope of this application.

The embodiments of this application provide a conference creation method and apparatus, and a computer-readable storage medium. The conference creation apparatus may be integrated in a computer device. The computer device may be devices such as a server or a terminal.

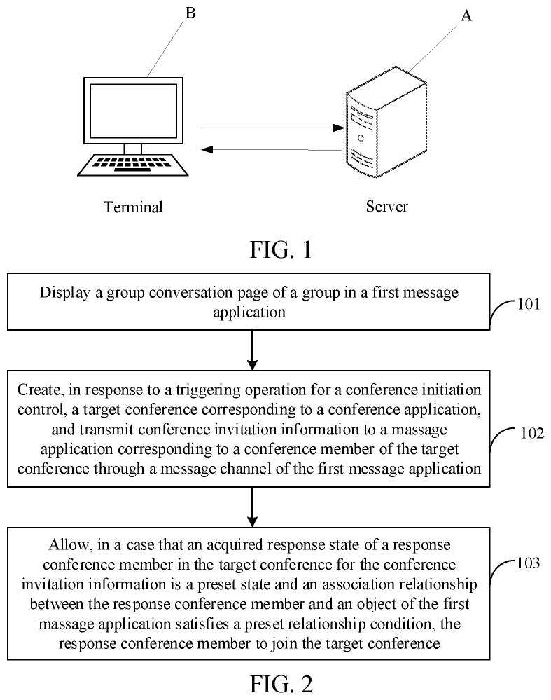

Referring to FIG. 1, taking a conference creation apparatus being integrated in a computer device as an example, FIG. 1 is a schematic diagram of an implementation scenario of a conference creation method provided by an embodiment of this application. The conference creation apparatus includes a server A and a terminal B. The server A may be an independent physical server, or may also be a server cluster or a distributed system composed of a plurality of physical servers, or may also be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In addition, the server A may be an interworking server among a plurality of heterogeneous messages (that is, messages from heterogeneous message systems), or a background server of a message system, or the like.

The terminal B may be various computer devices that may perform conference creation, such as a smartphone, a tablet computer, a notebook computer, a desktop computer, and a smartwatch, but is not limited thereto. The terminal B may display a group conversation page of a group in a first message application; create, in response to a triggering operation for a conference initiation control, a target conference corresponding to a conference application, and transmit conference invitation information to a message application corresponding to a conference member of the target conference through a message channel of the first message application; and allow, when an acquired response state of a response conference member in the target conference for the conference invitation information is a preset state and an association relationship between the response conference member and an object of the first message application satisfies a preset relationship condition, the response conference member to join the target conference.

The terminal B and the server A may be directly or indirectly connected in a wired or wireless communication mode, and the server A may acquire data uploaded by the terminal B to perform a corresponding operation. The embodiments of this application do not limit herein.

The schematic diagram of an implementation environment scenario of a conference creation method as shown in FIG. 1 is only an example. The implementation environment scenario of the conference creation method described in the embodiment of this application is to describe the technical solution of the embodiment of this application more clearly, and does not constitute a limitation to the technical solution provided by the embodiment of this application. Those of ordinary skill in the art may learn that, with the evolution of conference creation and the appearance of new service scenarios, the technical solutions provided by the embodiments of this application are also applicable to similar technical problems.

The following separately provides detailed descriptions. The description sequences of the following embodiments are not intended to limit preferred sequences of the embodiments.

The embodiments of this application will be described from the perspective of a conference creation apparatus. The conference creation apparatus may be specifically integrated into a computer device. The computer device may be a terminal. The embodiments of this application do not limit herein.

Referring to FIG. 2, FIG. 2 is a schematic flowchart of a conference creation method provided by an embodiment of this application. The conference creation method includes the following steps:

In step 101, a group conversation page of a group is displayed in a first message application.

The first message application may be an application for processing a message, and specifically, may perform processes such as receiving, transmitting, and displaying on the message. The group conversation page may include a conference initiation control. The conference initiation control may be a control used for initiating a conference, and may trigger the conference initiation control to perform a conference creation operation through operations such as clicking, and touching. The first message application may include at least one group, and the group may include at least one object. The object may be a member in a message system, a member in a single heterogeneous message system, or members in a plurality of heterogeneous message systems. The message system may be a system corresponding to the message system, and may include a terminal and a server installed with a message application. The terminal may transmit a message to the server through the message application. The terminal may transmit the message to a corresponding terminal, so as to realize message interaction of a plurality of terminals based on the message application. Each message system may correspond to one account type, for example, the object may be a member of a message system corresponding to a first message application, and the account type corresponding to the member may be an account type of the message system corresponding to the first message application.

The heterogeneous message system refers to that each of two or more message systems has an independent account system, a message data format, and an application function. Each message system maintains its own application characteristics and security control. A message from one message system can only be transmitted across systems by converting, through an interworking server, into a message data format that can be recognized by another message system.

In an embodiment, the group may further include at least one second object. the second object may be an object in a second message system. The second message system may be a message system corresponding to a second message application. The first message system and the second message system may be heterogeneous systems. The first message application and the second message application may be different applications. That is, the group may include objects in a plurality of heterogeneous message systems, for example, the group may include an object in the first message system and an object in the second message system.

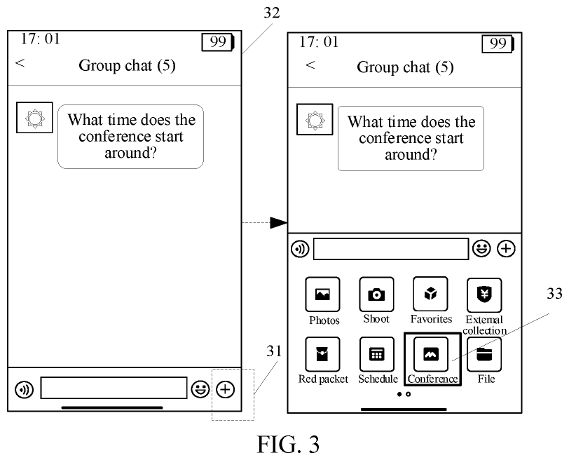

In an embodiment, referring to FIG. 3, FIG. 3 is a schematic diagram of a group conversation page of a conference creation method provided by an embodiment of this application. The group conversation page 32 may be used for a conversation between group members, and displaying group messages. When a user needs to initiates a conference, the user may open an option bar by triggering an option control 31 in the group conversation page, and may select a conference initiation control in the option bar to initiate a conference. For example, the conference initiation control 33 may also be directly displayed in the group conversation page, and the conference initiation control does not need to be acquired by opening an option control, which improves the operation efficiency.

In step 102, in response to a triggering operation for the conference initiation control, a target conference corresponding to a conference application is created, and conference invitation information is transmitted to a message application corresponding to a conference member of the target conference through a message channel of the first message application.

The conference application may be an application used for creating a conference. The target conference may be the conference created on the basis of the triggering operation for the conference initiation control. The conference member of the target conference may include at least one first object in the group. The first object may be an object in a first message system, that is, the first object may be an object with an account type being the account type corresponding to the first message system. The first message system may be a message system corresponding to the first message application. The conference invitation information may be information for inviting the conference member to join the target conference. The message channel may be a channel for transmitting a message between message applications.

The above channel may be established on the basis of various network communication protocols, such as a hyper text transfer protocol (HTTP), a hypertext transfer protocol secure (HTTPS) protocol of a HTTP channel with a goal of security.

In an embodiment, the conference member of the target conference may further include at least one second object. The second object is an object in a second message system. The second message system is a message system corresponding to a second message application. The first message system and the second message system are heterogeneous systems.

After the conference initiation control is triggered, the target conference corresponding to the conference application may be created in response to the triggering operation for the conference initiation control. There may be a plurality of manners for creating the target conference corresponding to the conference application, for example, a conference member selection page may be displayed; the conference member selection page includes at least one candidate object; a target object participating in the conference is selected from the candidate objects in response to an object selection operation for the conference member selection page; and the target conference corresponding to the conference application is created in the first message application.

The conference member selection page may be a page used for selecting a conference member from the candidate objects. The candidate object may have an association relationship with the object in the first message application. The candidate object may include at least one of the first object or a second object. The second object may be an object in a second message system. The second message system may be a message system corresponding to a second message application. The first message system and the second message system may be heterogeneous systems. The target object may be an object serving as a conference member in the candidate object.

As an example, the first message system may be a message system serving enterprise users. After registering in the first message system, all the enterprise users have identities belonging to an enterprise. The second message system may be a message system serving an individual user. After registering in the second message system, the individual user participates as an individual.

As an example, the first message system and the second message system may be used in scenarios such as online conference and instant messaging.

In an example, the conference member selection page includes at least one candidate object set. The candidate object set may include at least one candidate object. The candidate object set may include a first association object subset, a second association object subset, and a candidate group subset. The first association object subset includes at least one first object. The second association object subset includes at least one association second object. The association second object is a second object having an association relationship with the first message application. The candidate group subset includes at least one group in the first message application.

The first association object subset may be a whole composed of first objects in the first message application. The candidate group subset may be a whole composed of a plurality of groups in the first message application. The second association object subset may be a whole composed of second objects, having an association relationship with the first message application, in the second message system application.

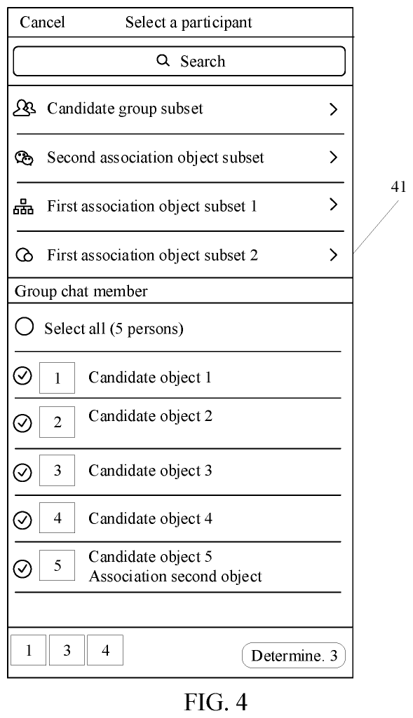

For example, referring to FIG. 4, FIG. 4 is a schematic diagram of a conference member selection page of a conference creation method provided by an embodiment of this application. The conference member selection page 41 may include a first association object subset, a second association object subset, and a candidate group subset. The first association object subset may include a plurality of categories (for example, a first association object subset 1 and a second association object subset 2). Taking the first message application being an enterprise application (for example, a client for enterprise instant messaging) as an example, the first association object subset may include a plurality of sources such as an internal member of the enterprise, upstream and downstream enterprise members of the current enterprise, and members across enterprises but belonging to the same group. For example, the first association object subset 1 may be an enterprise address book, and the first association object subset 1 may include the internal member of the enterprise, that is a first object with an account type being the account type corresponding to the first message system in the first message application. The second association object subset 2 may include address books from sources such as upstream and downstream enterprise members of the current enterprise, and members across enterprises but belonging to the same group. The candidate group subset may include a plurality of groups in the first message application, or may include a group that initiates a conference currently, and other groups. The group may include at least one type of object of the first object and the second object. The second association object subset may include a plurality of association second objects. In addition, the conference member selection page 41 may further display group chat members in the current group (that is, a group that initiates a conference), including a candidate object 1, a candidate object 2, a candidate object 3, a candidate object 4, a candidate object 5, and the like, which facilitates quick selection of the members in the group from the current group by a conference initiator. The candidate object 2 may be an object that initiates a conference in the group, that is, the object currently logged in to the first message application. The candidate object 5 may be a member with an account type of a second object in the current group, that is, an association second object.

After displaying the conference member selection page 41 and responding to the object selection operation of the conference member selection page, a target object participating in the conference may be selected from the candidate objects. There may be a plurality of manners for selecting the target object participating in the conference from the candidate objects, for example, a target candidate object subset may be determined in the candidate object set in response to a triggering operation for the candidate object set, at least one candidate object in the target candidate object subset may be displayed, and the target object participating in the conference in the candidate object may be determined in response to the triggering operation for the candidate object in the target candidate object subset.

The target candidate object subset may be a subset selected in the candidate object set on the basis of the triggering operation for the candidate object set, for example, one subset of the first association object subset, the second association object subset, and the candidate group subset.

Please continue to refer to FIG. 4, a user may select a target candidate object subset from the candidate object set in the conference member selection page 41, so that the target candidate object subset may be determined in the candidate object set in response to the triggering operation for the candidate object set, and at least one candidate object in the target candidate object subset may be displayed, and the target object participating in the conference in the candidate object may be determined in response to a triggering operation for the candidate object in the target candidate object subset. For example, assuming that the user selects the second association object subset, then the target candidate object subset may be determined as the second association object subset in the candidate object set in response to the triggering operation for the candidate object set, and at least one candidate object in the second association object subset may be displayed. In addition, the user may directly select a group chat member of the current group displayed in the conference member selection page 41, for example, continuing to refer to FIG. 4, the candidate object 1, the candidate object 3, the candidate object 4, and the candidate object 2 (which are selected as conference members by default) may be selected as target objects, which can improve the conference member selection speed, thereby improving the conference creation efficiency.

After selecting the target object participating in the conference from the candidate objects, a target conference corresponding to a conference application may be created in the first message application. There may be a plurality of manners for creating the target conference corresponding to the conference application in the first message application, for example, a conference creation request may be transmitted to the message system corresponding to the conference application through the first message system corresponding to the first message application, and then conference creation data that is transmitted by the message system corresponding to the conference application and that is based on the conference creation request may be acquired, so that the target conference corresponding to the conference application may be created in the first message application according to the conference creation data. The conference creation request may be a request used for requesting the message system corresponding to the conference application to create a conference. The conference creation data may be data used for creating the target conference. For example, the user may also join the target conference through the conference application, for example, joining the target conference in a form of a conference number or conference sharing (for example, a quick response code that bears a conference link or the conference number). Due to convenient and diversified conference participating manners, identity sources and way sources of conference participants are enriched, the convenience in conference creation is improved, and the conference creation efficiency is greatly improved.

There may be a plurality of manners for establishing an association relationship between the second object and the first message application, for example, a second object set in the second message application may be acquired in response to a triggering request for a second object association control in the first message application, the second object set may be displayed in the first message application, a target second object may be selected from second objects of the second object set, and the target second object may be added to the second association object subset of the first message application to obtain an association second object in the second association object subset.

The second object association control may be a control used for associating the second object in the second message application to the first message application. The second object set includes at least one second object. The target second object may be a second object selected from the second object set.

The second object set in the second message application may be acquired after responding to a triggering request for the second object association control in the first message application. There may be a plurality of manners for acquiring the second object set in the second message application, for example, a second object set acquisition request may be transmitted to an application interworking server through the first message application. The application interworking server may be a server between a first message system and a second message system, and is configured for message interaction between the first message application and the second message application, so that the application interworking server may acquire the second object set from the second message application and transmit the second object set to the first message application, thereby acquiring the second object set. For example, an account currently logged in to the first message application needs to be bound to an account logged in to the second message application to establish an association relationship between the first message application and the second message application, so that the second object set corresponding to the second message application may be acquired through the first message application.

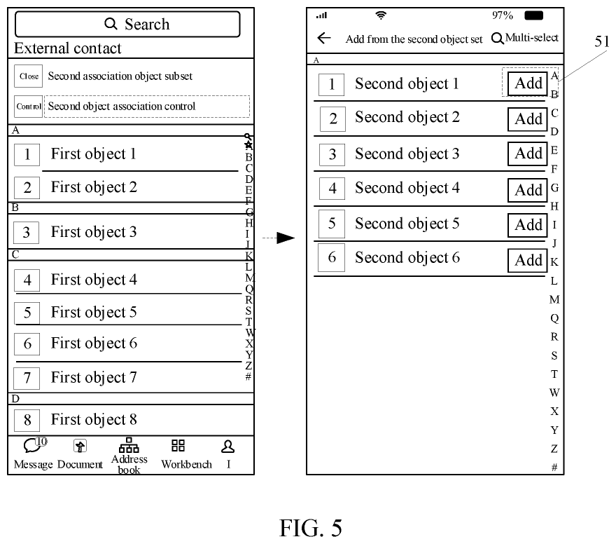

In an embodiment, referring to FIG. 5, FIG. 5 is a schematic diagram of second object association of a conference creation method provided by an embodiment of this application. An address book page in the first message application (as shown in a left figure in FIG. 5) includes a second object association control, a second association object subset, and a plurality of first objects including an address book of the first message application. On this basis, the second object association control in the first message control may be triggered, so that the second object set in the second message application may be acquired in response to a triggering request for the second object association control in the first message application, the second object set may be displayed in the first message application (as shown in a right figure in FIG. 5), a target second object may be selected from the second objects displayed in the first message application, and a corresponding adding control 51 may be triggered to add the target second object to the first message application, so that an association relationship between the second object in the second message application and the first message application may be established to obtain an association second object in the second association object subset.

Conference invitation information may be transmitted to a message application corresponding to a conference member of the target conference through a message channel of the first message application after the target conference corresponding to the conference application is created. There may be a plurality of manners for transmitting the conference invitation information to the message application corresponding to the conference member of the target conference through the message channel of the first message application, for example, when the conference member includes an object in a heterogeneous message system, due to a permission restriction between message systems, conference members of different message systems may correspond to different conference invitation reminding forms when conference invitation is performed, for example, the conference invitation information may include first conference invitation information or second conference invitation message. When the conference member is an object in the first message system, the first conference invitation information may be transmitted to the message application corresponding to the conference member through the message channel of the first message application. When the conference member is an object in the second message system, the second conference invitation message may be transmitted to the message application corresponding to the conference member through the message channel of the first message application.

The conference invitation information may be in a message reminding type supported by the first message system, for example, the conference invitation information may be in a message reminding type that is supported by the first message system and may perform message reminding between first message applications, and may be information for inviting the conference member with an object type being an object in the first message system to join the target conference. The second conference invitation message may be information for inviting the conference member with an object type not being an object in the first message system to join the target conference, for example, the second conference invitation message may be information for inviting the conference member with an object type being an object in the second message system to join the target conference.

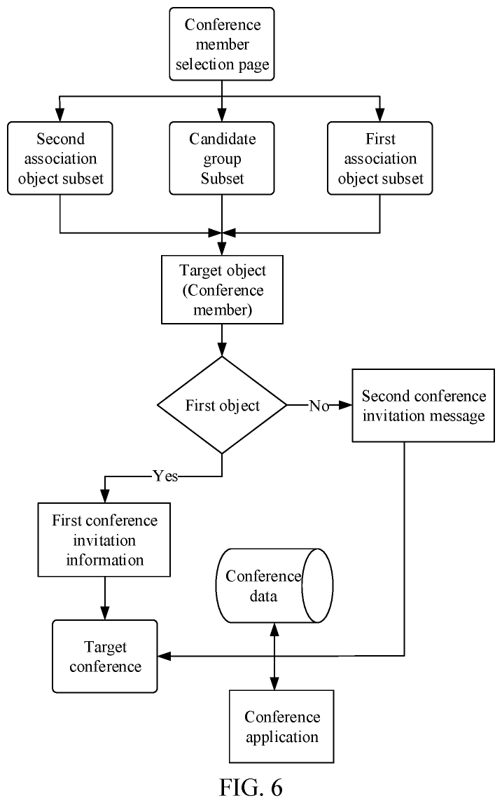

For example, referring to FIG. 6, FIG. 6 is a schematic diagram of a conference invitation process of a conference creation method provided by an embodiment of this application. After a target object (that is, a conference member) is selected on the basis of candidate object sets such as a first association object subset, a second association object subset, and a candidate group subset in a conference member selection page, whether the conference member is an object (that is, the first object) in the first message system may be determined. When the conference member is an object in the first message system, the first conference invitation information may be transmitted to the message application corresponding to the conference member through the message channel of the first message application. When the conference member is an object in the second message system, the second conference invitation message may be transmitted to the message application corresponding to the conference member through the message channel of the first message application, so as to invite the conference member to join the target conference.

For example, the first conference invitation information may include a conference invitation page and audio reminding information. The conference invitation page may include a first conference participation confirmation control. The first conference participation confirmation control may be used for adding the conference member to the target conference. The audio reminding information may be information that is supported by the first message system and that may perform message reminding between first message applications, for example, may be a ringing message.

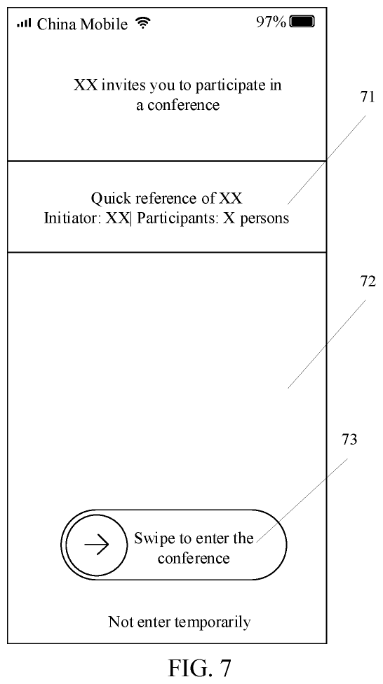

For example, referring to FIG. 7, FIG. 7 is a schematic diagram of first conference invitation information of a conference creation method provided by an embodiment of this application. After receiving the first conference invitation information 71, the target object may learn information such as an initiator and a number of participants of the target conference according to the information displayed in a conference invitation page 72, and join the target conference by swiping sliding a first conference participation confirmation control 73, or refuse to join the target conference by selecting a “not enter temporarily” control.

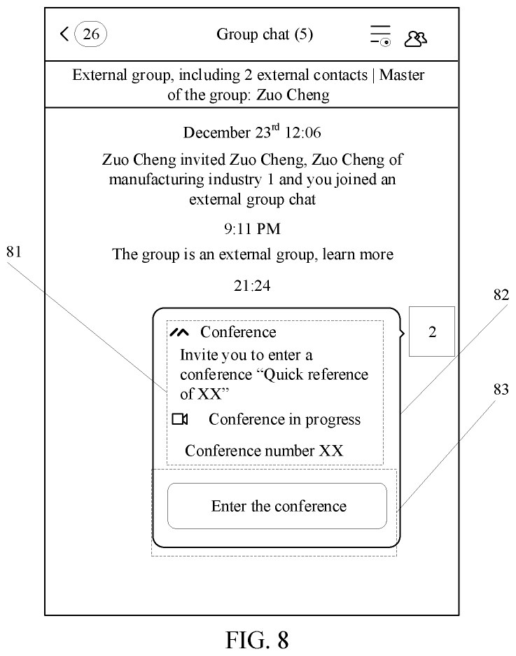

For example, the second conference invitation message may include a conference invitation card message. The conference invitation card message may include conference information corresponding to the target conference and a second conference participation confirmation control. The second conference participation confirmation control may be used for adding the conference member to the target conference. For example, referring to FIG. 8, FIG. 8 is a schematic diagram of second conference invitation message of a conference creation method provided by an embodiment of this application. According to the conference information 81 in the second conference invitation message, the conference information may include conference information such as conference name of the target conference, a conference initiator, a conference number, participants, conference time, and a conference theme. Meanwhile, a conference member may join the target conference by clicking a second conference participation confirmation control 83 in the second conference invitation message 82.

There may be a plurality of manners for transmitting the second conference invitation message to the conference member, for example, the second conference invitation message may be transmitted to the conference member through the first message application, the second conference invitation message may be displayed in a first conversation page corresponding to the conference member in the first message application, and the second conference invitation message may be synchronously transmitted to a second conversation page corresponding to the conference member in the second message application.

The first conversation page may be a conversation page corresponding to the conference member in the first message application. The second conversation page may be a conversation page corresponding to the conference member in the second message application. For example, assuming that an account currently logged in to the first message application is a first object A, and an account type of the first object A is an account type corresponding to the first message system, conference creation may be performed through a conference initiation control in the first message application on the basis of the first object A. Assuming that the first object A selects a target object B in the conference member selection page, an account type of the target object B is an account type corresponding to the second message system (that is, a second object), conference invitation information of the target conference may be transmitted for the conference member (the target object B), the second conference invitation message may be transmitted to the target object B through the first message application, the second conference invitation message may be displayed in a first conversation page of a conversation between the first object A and the target object B in the first message application, and the second conference invitation message may also be synchronously transmitted to the second conversation page of the conversation between the target object B in the second message application and the first object A. On this basis, a conference may be created across applications, which improves the conference creation speed while enriching the diversity of conference members, thereby improving the conference creation efficiency.

For example, there may be a plurality of manners for transmitting the second conference invitation message to the conference member, for example, if the conference member is an object in a group of the first message system, the second conference invitation message may be transmitted to the group corresponding to the conference member through a message channel of the first message application; and if the conference member is an association second object corresponding to the first message system, a conversation page corresponding to the conference member in a group of the first message system, the second conference invitation message is transmitted to a conversation page corresponding to the conference member in the first message application through the message channel of the first message application.

The association second object is a second object having an association relationship with the first message application.

For example, assuming that the account currently logged in to the first message application is the first object A, the account type of the first object A is an account type corresponding to the first message system, a conference may be created through a conference initiation control in the first message application on the basis of the first object A, and a conference member C is selected. When the conference member C is an object in the group of the first message system, the second conference invitation message may be transmitted to the group where the conference member C is located in the first message application through the message channel of the first message application. For example, when the conference member C is a member in the current group, the second conference invitation message may be transmitted to a group conversation page corresponding to the current group; and when the conference member C is not a member in the current group, the second conference invitation message may be transmitted to the group conversation page corresponding to the group where the conference member C is located through the message channel of the first message application, and meanwhile, the second conference invitation message may be blocked from other members in the group. When the conference member C is an association second object corresponding to the first message system, the second conference invitation message may be transmitted to the conversation page of a conversation between the first object A in the first message application and the conference member C through the message channel of the first message application. On this basis, conference invitation reminding between conference members across applications may be implemented, which enriches the diversity of conference members, thereby improving the conference creation efficiency.

For example, please continue to refer to FIG. 6, conference data of the target conference created in the first message system may be synchronized to the message system corresponding to the conference application. The conference data may include conference information, relevant data used for creating a conference, and the like. On this basis, sources of conference participants can be increased, the diversity of conference members can be enriched, and the conference creation efficiency can be improved.

For example, after transmitting the conference invitation information of the target conference for the conference member of the target conference, the conference information of the target conference may be synchronized to a third message system corresponding to the conference application through an interworking server. As an example, the conference message may include a conference name, a conference initiator, a conference number, participants, conference time, and a conference theme.

The interworking server is a server between the first message system and the third message system. The conference information of the conference created in the first message application may be synchronously transmitted to the conference application through the interworking server. Specifically, the conference information of the conference created in the first message application may be uploaded to the first message system, the conference information may be transmitted to the interworking server through the first message system, and then the conference information is synchronized to the conference application through the interworking server.

For example, modified conference information may be acquired from the third message system through the interworking server, and the modified conference information may be updated to the first message system.

The third message system may be a message system corresponding to the conference application. The modified conference information may be the conference information obtained by modifying the conference information of the target conference on the basis of the conference application.

Specifically, the conference information corresponding to the target conference may be modified on a conference application side, for example, modifying settings of the target conference, adjusting the participants of the target conference, adding conference information such as conference notes and documents to obtain modified conference information, then the modified conference information may be uploaded to a third message system, the modified conference information may be uploaded to the interworking server through the third message system, so that the modified conference information may be synchronized to the first message application through the interworking server. On this basis, the consistency of the conference data between two applications can be maintained.

In step 103, when an acquired response state of a response conference member in the target conference for the conference invitation information is a preset state and an association relationship between the response conference member and an object of the first message application satisfies a preset relationship condition, the response conference member is allowed to join the target conference.

The response conference member may be an object responding to the conference invitation information, for example, an object that triggers the conference invitation information and the like to join the target conference. The response state may be a state that the response conference member responding to the conference invitation information, for example, a state of accepting an invitation request initiated by the conference invitation information, refusing the invitation request initiated by the conference invitation information, or not responding to the invitation request of the conference invitation information. The preset state may be a preset response state, and is used for determining a preset condition whether to allow the response conference member to join the target conference, for example, the preset state may be a response state of accepting an invitation. The object of the first message application may be an object having an association relationship with the first message application, for example, a contact in the first message application, including at least one of the first object or the second object, an object corresponding to an account currently logged in to the first message application (that is, a user of the first message application), or a conference initiation object of the target conference. The association relationship may represent a relationship between the response conference member and the object in the first message application, for example, a friend relationship between the response conference member and the object in the first message application, or a position relationship between the response conference member and the object in the first message application, for example, the position relationship may be a position level relationship or a position nature relationship between the response conference member and the object in the first message application. The preset relationship condition may be a condition used for determining a permission of the response conference member on the basis of the association relationship between the response conference member and the object of the first message application, and whether the response conference member is allowed to join the target conference is further determined on the basis of the preset relationship condition.

For example, assuming that the preset state may be a response state of responding to the conference invitation information and accepting an invitation, and the preset relationship condition may be a condition that there is a friend relationship between the response conference member and the object of the first message application, when it is detected that the response conference member responds to the conference invitation information, the response state of the response conference member in the target conference for the conference invitation information and the association relationship between the response conference member and the object of the first message application are acquired. When the response state of the response conference member in the target conference for the conference invitation information is a preset state of accepting the invitation and the association relationship between the response conference member and the object of the first message application is a friend relationship, the response conference member may be allowed to join the target conference.

When the acquired response state of the response conference member in the target conference for the conference invitation information is the preset state and the association relationship between the response conference member and the object of the first message application satisfies the preset relationship condition, there may be a plurality of manners for allowing the response conference member to join the target conference, for example, the acquired response state of the response conference member in the target conference for the conference invitation information is the preset state, the association relationship between the response conference member and a conference initiation object corresponding to the target conference may be acquired, and the response conference member may be allowed to join the target conference when the association relationship matches the preset association relationship corresponding to the conference invitation information.

The conference initiation object may be an object that triggers a conference initiation control to create the target conference. The association relationship may be a relationship between the response conference member and the conference initiation object corresponding to the target conference, for example, a relationship between a position level corresponding to the response conference member and a position level corresponding to the conference initiation object, or a position nature matching relationship between a position type corresponding to the conference member and a position type corresponding to the conference initiation object, for example, the position nature matching relationship between a product planner and a product developer, between administrative personnel and non-administrative personnel, or the like, or the association relationship of an association degree and the like between the response conference member and the conference initiation object.

For example, in an enterprise application scenario, conference processes of some online conferences require personnel in specific positions to participate in the conferences for recording and attending the conferences, for example, personnel from human resources or finance departments, or, when the conference invitation information is transmitted to the group conversation page of the group, a member with higher position level may actively join the conference through the conference invitation information to understand the conference content and the conference progress. Therefore, the association relationship between the conference member that joins the target conference through the conference invitation information and is not selected when the target conference is created and the conference initiation object is authenticated, and the response conference member is added to the target conference according to an authentication result.

Specifically, when the acquired response state of the response conference member in the target conference for the conference invitation information is the preset state, for example, the response state of the response conference member for the conference invitation information is a state of accepting the invitation, or the response state of the response conference member for the conference invitation information is a state of requesting to join the conference, the association relationship between the response conference member and the conference initiation object corresponding to the target conference is acquired, for example, the association relationship may include a position level relationship between the response conference member and the conference initiation object corresponding to the target conference, or a position type of the response conference member, then, when the association relationship matches the preset association relationship condition corresponding to the conference invitation information, for example, the position level of the response conference member is higher than the position level of the conference initiation object corresponding to the target conference, or the position type of the response conference member conforms to a preset position type, the response conference member may be allowed to join the target conference.

In a conference creation method in related technologies, a conference creation process is generally completed in a closed loop in an independent application, and meanwhile, a conference member is selected on the basis of address book information of an independent application, so as to complete the creation of the whole conference process. This conference creation method is relatively cumbersome, and in scenarios with diverse sources of conference members such as a plurality of group chats and complex conference members, the conference cannot be created quickly, thereby resulting in poor conference creation efficiency. For this purpose, the embodiments of this application provide a conference creation method based on multi-application interaction. A conference initiation control is triggered in a group of the first message application, then objects in a plurality of group chats or heterogeneous systems may be selected as conference members through a conference member selection page to create the target conference, and communication across applications is supported, which breaks a traditional conference mode, enriches the identity sources of conference participants, and improves the convenience of a conference creation process, thereby improving the conference creation efficiency.

From the above, it can be known that, according to the embodiments of this application, a group conversation page of a group is displayed in a first message application, the group conversation page including a conference initiation control, and the group including at least one object; in response to a triggering operation for the conference initiation control, a target conference corresponding to a conference application is created, and conference invitation information is transmitted to a message application corresponding to a conference member of the target conference through a message channel of the first message application, the conference member of the target conference including at least one first object of the group, the first object being an object in a first message system, and the first message system being a message system corresponding to the first message application; and when an acquired response state of a response conference member in the target conference for the conference invitation information is a preset state and an association relationship between the response conference member and an object of the first message application satisfies a preset relationship condition, the response conference member is allowed to join the target conference. On this basis, the conference initiation control is displayed in the group conversation page of the group, so as to quickly create the target conference corresponding to the conference application in response to the triggering operation for the conference initiation control in the group conference page. For scenarios with diverse conference member sources, especially for the scenarios with conference members from a plurality of groups, the conference creation speed is greatly improved. Meanwhile, in the scenarios with diverse conference member sources and diverse conference reference ways, a response state and an association relationship of response conference members are authenticated, so that the response conference members satisfying a condition are allowed to join the target conference, which guarantees the security of a conference environment on the basis of quickly creating a conference, thereby improving the conference creation efficiency.

According to the method described in the above embodiments, the following further describes in details by using an example.

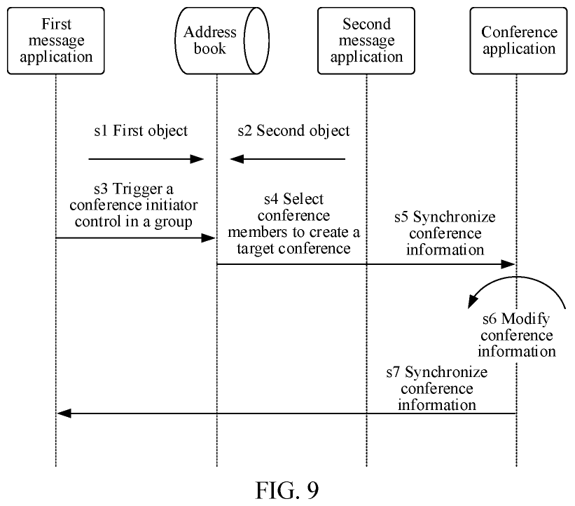

In the embodiments of this application, an example in which the conference creation apparatus is specifically integrated into a computer device is taken for description. The conference creation method is specifically described by taking a terminal as an execution subject. Specifically, referring to FIG. 9, FIG. 9 is a schematic diagram of a specific process of a conference creation method provided by an embodiment of this application.

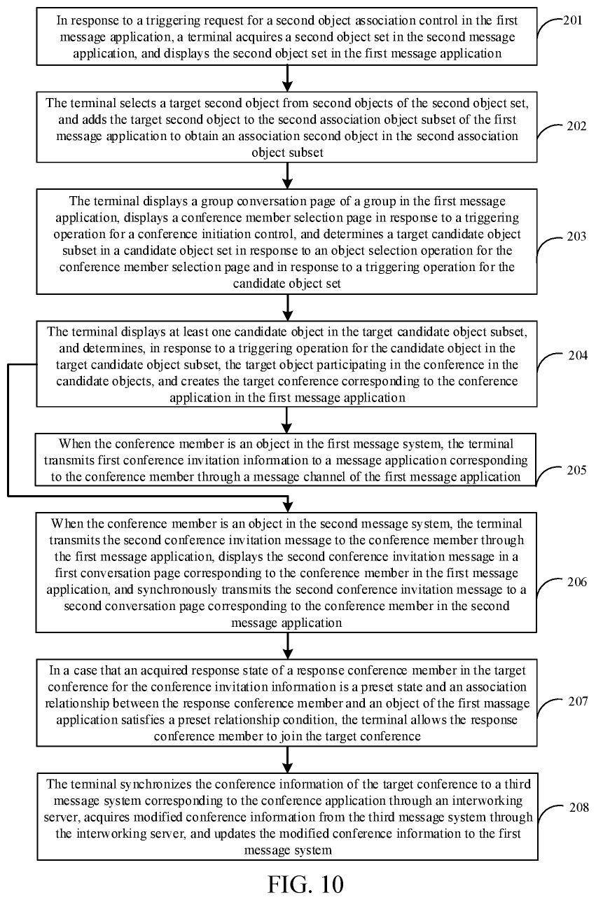

To better describe the embodiments of this application, refer to FIG. 9 and FIG. 10 together. As shown in FIG. 10, which is a schematic diagram of another process of a conversation creation method provided by an embodiment of this application. A specific process is as follows:

In step 201, in response to a triggering request for a second object association control in the first message application, a terminal acquires a second object set in the second message application, and displays the second object set in the first message application.

There may be a plurality of manners for the terminal to acquire the second object set in the second message application, for example, the terminal may transmit a second object set acquisition request to an application interworking server through the first message application. The application interworking server may be a server between a first message system and a second message system, and is configured for message interaction between the first message application and the second message application, so that the application interworking server may acquire the second object set from the second message application and transmit the second object set to the first message application, thereby acquiring the second object set.

For example, a plurality of applications may be installed in the terminal, including a first message application. An account currently logged in to the first message application needs to be bound to an account logged in to the second message application to establish an association relationship between the first message application and the second message application, so that the terminal may acquire the second object set corresponding to the second message application through the first message application.

In step 202, the terminal selects a target second object from second objects of the second object set, and adds the target second object to the second association object subset of the first message application to obtain an association second object in the second association object subset.

Refer to FIG. 5 for a specific example of step 202, which has been described above and will not described in detail.

On this basis, referring to FIG. 9, the terminal may select a conference member from an address book corresponding to the first message application. The address book may include a first object in the first message application, and a second object associated with the first message application in the second message application.

In step 203, the terminal displays a group conversation page of a group in the first message application, displays a conference member selection page in response to a triggering operation for a conference initiation control, and determines a target candidate object subset in a candidate object set in response to an object selection operation for the conference member selection page and in response to a triggering operation for the candidate object set.

After displaying the conference member selection page and responding to the object selection operation of the conference member selection page, the terminal may determine the target candidate object subset in the candidate object set in response to the triggering operation for the candidate object set.

For example, referring to the above description of FIG. 4, a user may select the target candidate object subset in the candidate object set in the conference member selection page 41, so that the terminal may determine the target candidate object subset in the candidate object set in response to the triggering operation for the candidate object set.

In step 204, the terminal displays at least one candidate object in the target candidate object subset, and determines, in response to a triggering operation for the candidate object in the target candidate object subset, the target object participating in the conference in the candidate objects, and creates the target conference corresponding to the conference application in the first message application.

For example, assuming that the user selects a second association object subset, the terminal may determine the target candidate object subset as a second association object subset in the candidate object set in response to a triggering operation for the candidate object set, and display at least one candidate object in the second association object subset. In addition, the user may directly select a group chat member of the current group displayed in the conference member selection page, for example, continuing to refer to FIG. 4, the terminal may select the candidate object 1, the candidate object 3, the candidate object 4, and the candidate object 2 (which are selected as conference members by default) as target objects, which can improve the conference member selection speed, thereby improving the conference creation efficiency.

After selecting the target objects participating in the conference from the candidate objects, the terminal may create a target conference corresponding to a conference application in the first message application. There may be a plurality of manners for creating the target conference corresponding to the conference application in the first message application, for example, the terminal may transmit a conference creation request to the message system corresponding to the conference application through the first message system corresponding to the first message application, and then may acquire conference creation data that is transmitted by the message system corresponding to the conference application and that is based on the conference creation request, so that the target conference corresponding to the conference application may be created in the first message application according to the conference creation data.

For example, the user may also join the target conference through the conference application, for example, joining the target conference in a form of a conference number or conference sharing. Due to convenient and diversified conference participating manners, identity sources and way sources of conference participants are enriched, the convenience in conference creation is improved, and the conference creation efficiency is greatly improved.

In step 205, when the conference member is an object in the first message system, the terminal transmits first conference invitation information to a message application corresponding to the conference member through a message channel of the first message application.

When the conference member includes an object in a heterogeneous message system, due to a permission restriction between message systems, conference members of different message systems may correspond to different conference invitation reminding forms when conference invitation is performed. When the conference member is an object in the first message system, the terminal may transmit the first conference invitation information to the message application corresponding to the conference member.

For example, the first conference invitation information may include a conference invitation page and audio reminding information. The conference invitation page may include a first conference participation confirmation control. The first conference participation confirmation control may be used for adding the conference member to the target conference. The audio reminding information may be information that is supported by the first message system and that may perform message reminding between first message applications, for example, may be a ringing message.

Referring to descriptions of FIG. 7 and FIG. 8 to understand step 205, which will not be repeated here.

In step 206, when the conference member is an object in the second message system, the terminal transmits the second conference invitation message to the conference member through the first message application, displays the second conference invitation message in a first conversation page corresponding to the conference member in the first message application, and synchronously transmits the second conference invitation message to a second conversation page corresponding to the conference member in the second message application.

For example, the second conference invitation message may include a conference invitation card message. The conference invitation card message may include conference information corresponding to the target conference and a second conference participation confirmation control. The second conference participation confirmation control may be used for adding the conference member to the target conference.

For example, there may be a plurality of manners for the terminal to transmit the second conference invitation message to the conference member, for example, if the conference member is an object in a group in the first message system, the terminal may transmit the second conference invitation message to the group corresponding to the conference member; and if the conference member is an association second object corresponding to the first message system, the terminal may transmit the second conference invitation message to the conversation page corresponding to the conference member in the first message application.

In step 207, when an acquired response state of a response conference member in the target conference for the conference invitation information is a preset state and an association relationship between the response conference member and an object of the first message application satisfies a preset relationship condition, the terminal allows the response conference member to join the target conference.

In an embodiment, the conference invitation information may be the second conference invitation message, a position level relationship between the response conference member and the conference initiation object corresponding to the target conference may be acquired when the response conference member accepts the conference invitation request of the conference invitation information through the second conference invitation message; and the terminal may allow the response conference member to join the target conference when the position level of the response conference member is higher than the position level of the conference initiation object corresponding to the target conference.

Referring to the above description for the preset state and the preset relationship condition, which will not be described repeatedly here.

In step 208, the terminal synchronizes the conference information of the target conference to a third message system corresponding to the conference application through an interworking server, acquires modified conference information from the third message system through the interworking server, and updates the modified conference information to the first message system.

The interworking server is a server between the first message system and the third message system. The terminal may synchronously transmit the conference information of the conference created in the first message application to the conference application through the interworking server. Specifically, the terminal may upload the conference information of the conference created in the first message application to the first message system, transmit the conference information to the interworking server through the first message system, and then synchronize the conference information to the conference application through the interworking server.

Specifically, the terminal may modify the conference information corresponding to the target conference on a conference application side, for example, modifying settings of the target conference, adjusting the participants of the target conference, adding conference information such as conference notes and documents to obtain modified conference information, then upload the modified conference information to a third message system, and upload the modified conference information to the interworking server through the third message system, so that the modified conference information may be synchronized to the first message application through the interworking server. On this basis, the consistency of the conference data between two applications can be maintained.

In a conference creation method in related technologies, a conference creation process is generally completed in a closed loop in an independent application, and meanwhile, a conference member is selected on the basis of address book information of an independent application, so as to complete the creation of the whole conference process. This conference creation method is relatively cumbersome, and in scenarios with diverse sources of conference members such as a plurality of group chats and complex conference members, the conference cannot be created quickly, thereby resulting in poor conference creation efficiency. For this purpose, the embodiments of this application provide a conference creation method based on multi-application interaction. A conference initiation control is triggered in a group of the first message application, then objects in a plurality of group chats or heterogeneous systems may be selected as conference members through a conference member selection page to create the target conference, and communication across applications is supported, which breaks a traditional conference mode, enriches the identity sources of conference participants, and improves the convenience of a conference creation process, thereby improving the conference creation efficiency.

From the above, it can be known that, according to the embodiments of this application, the conference initiation control is displayed in the group conversation page of the group, and then the candidate object from the heterogeneous message system is selected in the candidate object set in response to a triggering operation for the conference initiation control in the group conference page, so as to quickly create the target conference corresponding to the conference application, and the conference invitation information is transmitted across applications in different forms for the conference members in different message systems. For scenarios with diverse conference member sources, especially for the scenarios with conference members from a plurality of groups, the conference creation speed is greatly improved, and meanwhile, the diversity of the conference members is greatly enriched. Meanwhile, in the scenarios with diverse conference member sources and diverse conference reference ways, a response state and an association relationship of response conference members are authenticated, so that the response conference members satisfying a condition are allowed to join the target conference, which guarantees the security of a conference environment on the basis of quickly creating a conference, thereby improving the conference creation efficiency.

According to the method described in the above embodiments, the following further describes in details by using an example.

In the embodiments of this application, a conference creation method is further provided, which includes:
displaying a group conversation page of a group in a first message application, the group conversation page including a conference initiation control, and the group including at least one object; creating, in response to a triggering operation for the conference initiation control, a target conference corresponding to a conference application, the conference member of the target conference including at least one first object of the group, the first object being an object in a first message system, and the first message system being a message system corresponding to the first message application; and transmitting conference invitation information of the target conference for the conference member of the target conference.

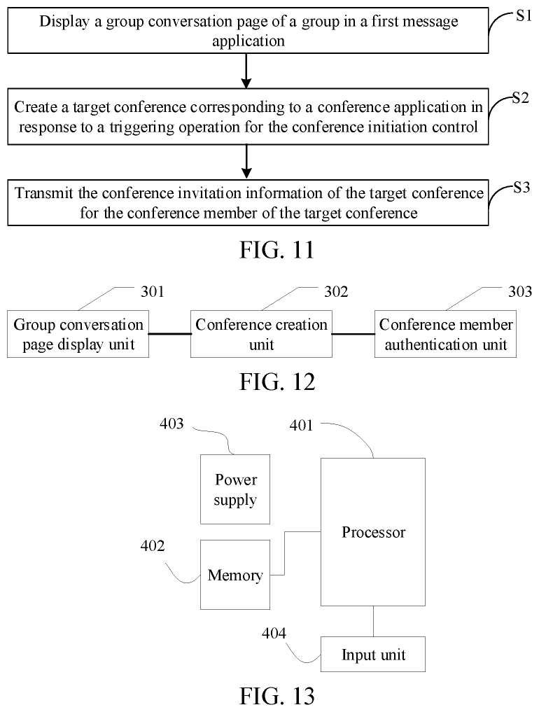

As shown in FIG. 11, a specific process of the conference creation method is as follows:

S1: Display a group conversation page of a group in a first message application.

The group conversation page includes a conference initiation control, and the group includes at least one object. Referring to FIG. 3 to understand the group conversation page, which will not be described repeatedly here.

S2: Create a target conference corresponding to a conference application in response to a triggering operation for the conference initiation control.

After displaying a conference member selection page and responding to an object selection operation of the conference member selection page, a target object participating in the conference may be selected from the candidate objects. There may be a plurality of manners for selecting the target object participating in the conference from the candidate object, for example, a target candidate object subset may be determined in the candidate object set in response to a triggering operation for the candidate object set, at least one candidate object in the target candidate object subset may be displayed, and the target object participating in the conference in the candidate object may be determined in response to the triggering operation for the candidate object in the target candidate object subset.

S3: Transmit conference invitation information of the target conference for the conference member of the target conference.

There may be a plurality of manners for transmitting the conference invitation information of the target conference for the conference member of the target conference, for example, the conference invitation information of the target conference may be transmitted to a conference invitation information receiving page corresponding to the conference member, and a to-be-authenticated object is added to the target conference as the conference member in response to a triggering operation for the to-be-authenticated object for the conference invitation information in the conference invitation information receiving page and when the to-be-authenticated object satisfies a preset permission.

From the above, it can be known that, according to the embodiments of this application, a group conversation page of a group is displayed in a first message application, the group conversation page includes a conference initiation control, and the group includes at least one object. In response to a triggering operation for the conference initiation control, a target conference corresponding to a conference application is created, the conference member of the target conference includes at least one first object of the group, the first object is an object in a first message system, and the first message system is a message system corresponding to the first message application. The conference invitation information of the target conference is transmitted for the conference member of the target conference. On this basis, the conference initiation control is displayed in the group conversation page of the group, so as to quickly create the target conference corresponding to the conference application in response to the triggering operation for the conference initiation control in the group conference page. For scenarios with diverse conference member sources, especially for the scenarios with conference members from a plurality of groups, the conference creation speed is greatly improved.

To better implement the above method, the embodiments of this application further provide conference creation apparatus. The conference creation apparatus may be integrated in a computer device. The computer device may be a terminal.

For example, as shown in FIG. 12, it is a schematic structural diagram of a conference creation apparatus provided by an embodiment of this application. The conference creation apparatus may include a group conversation page display unit 301, a conference creation unit 302, and a conference member authentication unit 303 as follows.

The group conversation page display unit 301 is configured to display a group conversation page of a group in a first message application. The group conversation page includes a conference initiation control, and the group includes at least one object.

The conference creation unit 302 is configured to create, in response to a triggering operation for the conference initiation control, a target conference corresponding to a conference application is created, and transmit conference invitation information to a message application corresponding to a conference member of the target conference through a message channel of the first message application. The conference member of the target conference includes at least one first object of the group, the first object is an object in a first message system, and the first message system is a message system corresponding to the first message application.

The conference member authentication unit 303 is configured to allow, when an acquired response state of a response conference member in the target conference for the conference invitation information is a preset state and an association relationship between the response conference member and an object of the first message application satisfies a preset relationship condition, the response conference member to join the target conference.

In an embodiment, the conference member of the target conference further includes: at least one second object. The second object is an object in a second message system. The second message system is a message system corresponding to a second message application. The first message system and the second message system are heterogeneous systems.

In an embodiment, the group further includes: at least one second object. The second object is an object in a second message system. The second message system is a message system corresponding to a second message application. The first message system and the second message system are heterogeneous systems.

In an embodiment, the conference creation unit 302 includes: a conference member selection page display subunit, configured to display a conference member selection page, the conference member selection page including at least one candidate object, the candidate object having an association relationship with an object in the first message application, the candidate object including at least one of a first object or a second object, the second object being an object in a second message system, the second message system being a message system corresponding to the second message application, and the first message system and the second message system being heterogeneous systems;
a target object selection subunit, configured to select, in response to an object selection operation for the conference member selection page, a target object participating in a conference from the candidate objects; and
a target conference creation subunit, configured to create the target conference corresponding to the conference application in the first message application, the target object being a conference member in the target conference.

In an embodiment, the conference member selection page includes: at least one candidate object set. The candidate object set includes at least one candidate object. The candidate object set may include a first association object subset, a second association object subset, and a candidate group subset. The first association object subset includes at least one first object. The second association object subset includes at least one association second object. The association second object is a second object having an association relationship with the first message application. The candidate group subset includes at least one group in the first message application.

In an embodiment, the conference creation apparatus further includes: a second object set acquisition unit, configured to acquire, in response to a triggering request for a second object association control in the first message application, a second object set in the second message application, the second object set including at least one second object; a target second object selection unit, configured to display the second object set in the first message application, and select a target second object from second objects of the second object set; and a target second object adding unit, configured to add the target second object to the second association object subset of the first message application to obtain the association second object in the second association object subset.

In an embodiment, the target object section subunit includes: a target candidate object subset determination module, configured to determine a target candidate object subset in the candidate object set in response to the triggering operation for the candidate object set; a candidate object display module, configured to display at least one candidate object in the target candidate object subset; and a target object determination module, configured to determine, in response to a triggering operation for the candidate object in the target candidate object subset, the target object participating in the conference in the candidate objects.

In an embodiment, the conference invitation information includes first conference invitation information or a second conference invitation message. The conference member authentication unit includes:
a first conference invitation information transmitting subunit, configured to transmit, when the conference member is an object in the first message system, the first conference invitation information to a message application corresponding to the conference member through the message channel of the first message application, the first conference invitation information being in a message reminding type supported by the first message system; and
a second conference invitation message transmitting subunit, configured to transmit, when the conference member is an object in the second message system, the second conference invitation message to a message application corresponding to the conference member through the message channel of the first message application.

In an embodiment, the first conference invitation information includes: a conference invitation page and audio reminding information, the conference invitation page includes a first conference participation confirmation control, and the first conference participation confirmation is used for adding the conference member to the target conference.

In an embodiment, the second conference invitation message includes: a conference invitation card message. The conference invitation card message includes conference information corresponding to the target conference and a second conference participation confirmation control. The second conference participation confirmation control is used for adding the conference member to the target conference.

In an embodiment, the second conference invitation message transmitting subunit includes: a conference invitation message display module, configured to transmit the second conference invitation message to the conference member through first message application, and display the second conference invitation message in the first conversation page corresponding to the conference member in the first message application; and

a conference invitation message transmitting module, configured to synchronously transmit the second conference invitation message to a second conversation page corresponding to the conference member in the second message application.

In an embodiment, the second conference invitation message transmitting subunit includes: a group conference invitation message transmitting module, configured to transmit, when the conference member is an object in the group the first message system, the second conference invitation message to the group corresponding to the conference member through the message channel of the first message application;
an object conference invitation message transmitting module, configured to transmit, when the conference member is an association second object corresponding to the first message system, the second conference invitation message to a conversation page corresponding to the conference member in the first message application through a message channel of the first message application, the association second object is a second object having an association relationship with the first message application.

In an embodiment, the conference member authentication unit 303 includes: an association relationship acquisition subunit, configured to acquire, when an acquired response state of the response conference member in the target conference for the conference invitation information is the preset state, an association relationship between the response conference member and a conference initiation object corresponding to the target conference; and
a conference member adding subunit, configured to allow, when the association relationship matches a preset association relationship condition corresponding to the conference invitation information, the response conference member to join the target conference.

In an embodiment, the conference creation apparatus further includes: a conference information synchronization unit, configured to synchronize, through an interworking server, conference information of the target conference to a third message system corresponding to the conference application, the interworking server being a server between the first message system and the third message system.

In an embodiment, the conference creation apparatus further includes: a modified conference information acquisition unit, configured to acquire modified conference information from the third message system through the interworking server, the modified conference information being the conference information obtained by modifying the conference information of the target conference on the basis of the conference application; and a modified conference information modification unit, configured to update the modified conference information into the first message system.

During a specific implementation, all units above may be implemented as independent entities, or may be randomly combined, or may be implemented as the same entity or several entities. For specific implementations of all units above, refer to the foregoing method embodiments. Details are not described herein again.

From the above, it can be known that, according to the embodiments of this application, the conference initiation control is displayed in the group conversation page of the group, so as to quickly create the target conference corresponding to the conference application in response to the triggering operation for the conference initiation control in the group conference page. For scenarios with diverse conference member sources, especially for the scenarios with conference members from a plurality of groups, the conference creation speed is greatly improved. Meanwhile, in the scenarios with diverse conference member sources and diverse conference reference ways, a response state and an association relationship of response conference members are authenticated, so that the response conference members satisfying a condition are allowed to join the target conference, which guarantees the security of a conference environment on the basis of quickly creating a conference, thereby improving the conference creation efficiency.

The embodiments of this application further provide a computer device, as shown in FIG. 13, which shows a schematic structural diagram of a computer device involved in the embodiments of this application. The computer device may be a terminal, specifically:
the computer device may include components such as a processor 401 including one or more processing cores above, a memory 402 including one or more computer-readable storage media above, a power supply 403, and an input unit 404. Those skilled in the art can understand that, a structure of the computer device shown in FIG. 13 does not constitute a limitation on the computer device, and may include components that are more or fewer than those shown in the figure, or a combination of some components, or different component arrangements.

The processor 401 is a control center of the computer device, and connects to various parts of the entire computer device by using various interfaces and lines. By running or executing software programs and/or modules stored in the memory 402, and invoking data stored in the memory 402, various functions and data processing of the computer device are performed. For example, the processor 401 may include one or more processing cores. The processor 401 may integrate an application processor and a modem. The application processor mainly processes an operating system, a user interface, an application program, and the like. The modem mainly processes wireless communication. It may be understood that the foregoing modem may not be integrated into the processor 401.

The memory 402 may be configured to store software programs and modules. The processor 401 runs the software programs and modules stored in the memory 402 to execute various functional applications and conference creations. The memory 402 may mainly include a program storage area and a data storage area. The program storage area may store an operating system, an application program required by at least one function (for example, a sound playing function and an image playing function), or the like. The data storage area may store data created according to use of the computer device. In addition, the memory 402 may include a high speed random access memory, and may also include a non-volatile memory, for example, at least one magnetic disk storage device, a flash memory device, or other volatile solid-state storage devices. Correspondingly, the memory 402 may further include a memory controller to provide access of the processor 401 to the memory 402.

The computer device further includes the power supply 403 supplying power to various components. The power supply 403 may be logically connected to the processor 401 by using a power supply management system, so as to realize a function of managing charge, discharge, power consumption, and the like by using the power supply management system. The power supply 403 may further include one or more of a direct current or alternating current power supply, a re-charging system, a power failure detection circuit, a power supply converter or inverter, a power supply state indicator, and any other components.

The computer device may further include the input unit 404. The input unit 404 may be configured to receive input numeric or character information and generate keyboard, mouse, joystick, optical, or trackball signal input related to user settings and function control.

Although not shown in the figure, the computer device may further include a display unit and the like. Details are not described herein again. Specifically, in the embodiments of this application, the processor 401 in the computer device will load executable files corresponding to processes of one or more applications into the memory 402 according to the following instructions, and the processor 401 runs the applications stored in the memory 402 to implement the above conference creation method.

For specific implementations of all operations above, refer to the foregoing embodiments. Details are not described herein again. The computer device provided by the embodiments of this application and the method applicable to creating a conference in the previous embodiments belong to the same conception. For details of a specific implementation process, refer to the method embodiments above. Details are not described herein again.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. Those of ordinary skill in the art may understand that all or part steps of all methods above in the foregoing embodiments may be implemented by using instructions, or implemented by instructions controlling relevant hardware. The instructions may be stored in a computer-readable memory and loaded and executed by a processor.

For the purpose, the embodiments of this application provide a computer-readable storage medium, storing a plurality of instructions. The instructions are capable of being loaded by a processor to perform steps in any conference creation method provided by the embodiments of this application. The computer-readable storage medium may include: a read-only memory (ROM), a random access memory (RAM), a magnetic disk, an optical disk, or the like.

Since the instructions stored in the computer-readable storage medium may perform steps of any conference creation method provided by the embodiments of this application, beneficial effects that may be achieved by any conference creation method provided by the embodiments of this application can be achieved. Refer to the foregoing embodiments for details. Details are not described herein again.

According to an aspect of this application, a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, so that the computer device performs the method provided by various optional implementations provided by the above embodiments.

The conference creation method and apparatus, and the computer-readable storage medium provided by the embodiments of this application are described above in detail. Although principles and implementations of this application are described by using specific examples herein, the descriptions of the above embodiments are merely intended to help understand the method and its core idea of this application. Meanwhile, those skilled in the art may make modifications to the specific implementations and application scopes according to the ideas of this application. In conclusion, the content of the specification is not be construed as a limitation to this application.

What is claimed is:

1. A conference creation method performed by a computer device, the method comprising:
displaying a group conversation page of a group in a first message application, the group conversation page comprising a conference initiation control;
in response to a triggering operation for the conference initiation control, creating a target conference corresponding to a conference application and transmitting conference invitation information to a conference member of the target conference through a message channel of the first message application, the conference member of the target conference comprising at least one first member of the first message application; and
when an acquired response state of the conference member in the target conference for the conference invitation information is a preset state and an association relationship between the response conference member and the at least first member of the first message application satisfies a preset relationship condition, allowing the response conference member to join the target conference.

2. The method according to claim 1, wherein the conference member of the target conference further comprises at least one second member of a second message application, and the first message application and the second message application are heterogeneous systems.

3. The method according to claim 1, wherein the group further comprises at least one second member of a second message application, and the first message application and the second message application are heterogeneous systems.

4. The method according to claim 1, wherein the creating a target conference corresponding to a conference application comprises:
displaying a conference member selection page, the conference member selection page comprising at least one candidate member, the candidate member having an association relationship with a member in the first message application, the candidate member comprising at least one of the first member or a second member of a second message application, and the first message application and the second message application are heterogeneous systems;
in response to an object selection operation for the conference member selection page, selecting a target member participating in a conference from the candidate members; and
creating the target conference corresponding to the conference application in the first message application, the target member being the conference member in the target conference.

5. The method according to claim 1, wherein the conference invitation information comprises first conference invitation information and a second conference invitation message, and the transmitting conference invitation information to a conference member of the target conference through a message channel of the first message application comprises:
transmitting the first conference invitation information to a message application corresponding to the conference member through the message channel of the first message application; and
transmitting the second conference invitation message to a message application corresponding to the conference member through the message channel of the first message application.

6. The method according to claim 1, wherein the allowing the response conference member to join the target conference comprises:
acquiring an association relationship between the response conference member and a conference initiation object corresponding to the target conference; and
when the association relationship matches a preset association relationship condition corresponding to the conference invitation information, allowing the response conference member to join the target conference.

7. The method according to claim 1, wherein, after allowing the response conference member to join the target conference, the method further comprises:
synchronizing, through an interworking server, conference information of the target conference to a third message system corresponding to the conference application, the interworking server being a server between the first message system and the third message system.

8. A computer device, comprising a memory, a processor, and a computer program that is stored in the memory, when executed by the processor, causes the computer device to perform a conference creation method including:
displaying a group conversation page of a group in a first message application, the group conversation page comprising a conference initiation control;
in response to a triggering operation for the conference initiation control, creating a target conference corresponding to a conference application and transmitting conference invitation information to a conference member of the target conference through a message channel of the first message application, the conference member of the target conference comprising at least one first member of the first message application; and
when an acquired response state of the conference member in the target conference for the conference invitation information is a preset state and an association relationship between the response conference member and the at least first member of the first message application satisfies a preset relationship condition, allowing the response conference member to join the target conference.

9. The computer device according to claim 8, wherein the conference member of the target conference further comprises at least one second member of a second message application, and the first message application and the second message application are heterogeneous systems.

10. The computer device according to claim 8, wherein the group further comprises at least one second member of a second message application, and the first message application and the second message application are heterogeneous systems.

11. The computer device according to claim 8, wherein the creating a target conference corresponding to a conference application comprises:
displaying a conference member selection page, the conference member selection page comprising at least one candidate member, the candidate member having an association relationship with a member in the first message application, the candidate member comprising at least one of the first member or a second member of a second message application, and the first message application and the second message application are heterogeneous systems;
in response to an object selection operation for the conference member selection page, selecting a target member participating in a conference from the candidate members; and
creating the target conference corresponding to the conference application in the first message application, the target member being the conference member in the target conference.

12. The computer device according to claim 8, wherein the conference invitation information comprises first conference invitation information and a second conference invitation message, and the transmitting conference invitation information to a conference member of the target conference through a message channel of the first message application comprises:
transmitting the first conference invitation information to a message application corresponding to the conference member through the message channel of the first message application; and
transmitting the second conference invitation message to a message application corresponding to the conference member through the message channel of the first message application.

13. The computer device according to claim 8, wherein the allowing the response conference member to join the target conference comprises:
acquiring an association relationship between the response conference member and a conference initiation object corresponding to the target conference; and
when the association relationship matches a preset association relationship condition corresponding to the conference invitation information, allowing the response conference member to join the target conference.

14. The computer device according to claim 8, wherein, after allowing the response conference member to join the target conference, the method further comprises:
synchronizing, through an interworking server, conference information of the target conference to a third message system corresponding to the conference application, the interworking server being a server between the first message system and the third message system.

15. A non-transitory computer-readable storage medium, storing a plurality of instructions, and the instructions being configured to be executed by a processor of a computer device and cause the computer device to perform a conference creation method including:
displaying a group conversation page of a group in a first message application, the group conversation page comprising a conference initiation control;
in response to a triggering operation for the conference initiation control, creating a target conference corresponding to a conference application and transmitting conference invitation information to a conference member of the target conference through a message channel of the first message application, the conference member of the target conference comprising at least one first member of the first message application; and
when an acquired response state of the conference member in the target conference for the conference invitation information is a preset state and an association relationship between the response conference member and the at least first member of the first message application satisfies a preset relationship condition, allowing the response conference member to join the target conference.

16. The non-transitory computer-readable storage medium according to claim 15, wherein the conference member of the target conference further comprises at least one second member of a second message application, and the first message application and the second message application are heterogeneous systems.

17. The non-transitory computer-readable storage medium according to claim 15, wherein the group further comprises at least one second member of a second message application, and the first message application and the second message application are heterogeneous systems.

18. The non-transitory computer-readable storage medium according to claim 15, wherein the creating a target conference corresponding to a conference application comprises:
displaying a conference member selection page, the conference member selection page comprising at least one candidate member, the candidate member having an association relationship with a member in the first message application, the candidate member comprising at least one of the first member or a second member of a second message application, and the first message application and the second message application are heterogeneous systems;
in response to an object selection operation for the conference member selection page, selecting a target member participating in a conference from the candidate members; and
creating the target conference corresponding to the conference application in the first message application, the target member being the conference member in the target conference.

19. The non-transitory computer-readable storage medium according to claim 15, wherein the conference invitation information comprises first conference invitation information and a second conference invitation message, and the transmitting conference invitation information to a conference member of the target conference through a message channel of the first message application comprises:
transmitting the first conference invitation information to a message application corresponding to the conference member through the message channel of the first message application; and
transmitting the second conference invitation message to a message application corresponding to the conference member through the message channel of the first message application.

20. The non-transitory computer-readable storage medium according to claim 15, wherein the allowing the response conference member to join the target conference comprises:
acquiring an association relationship between the response conference member and a conference initiation object corresponding to the target conference; and
when the association relationship matches a preset association relationship condition corresponding to the conference invitation information, allowing the response conference member to join the target conference.
